(19) United States
(12) Patent Application Publication
(10) Pub. No.: US 2012/0193085 A1
(43) Pub. Date: Aug. 2, 2012

(54) HEATSINK FOR LED ARRAY LIGHT

(76) Inventors: James Eldred Whittle, Clinton, UT (US); Allen Raymond Whittle, Clinton, UT (US)

(21) Appl. No.: 13/364,235

(22) Filed: Feb. 1, 2012

Related U.S. Application Data
(60) Provisional application No. 61/438,555, filed on Feb. 1, 2011.

(51) Int. Cl. F28F 7/00; B23P 15/26

(52) U.S. Cl. 165/185; 29/890.03

(57) ABSTRACT

A heatsink that includes a plurality of thermally conductive plates coupled to each other in a stacked configuration. Each plate includes a core section and a plurality of protrusions extending radially outwardly from the core section in a direction substantially parallel to the core section. The core section of each plate is in direct contact with the core section of an adjacent plate.

### CROSS-REFERENCE TO RELATED APPLICATION

This application claims the benefit of U.S. Provisional Patent Application No. 61/438,555, filed Feb. 1, 2011, which is incorporated herein by reference.

### FIELD

This application is related generally to heatsinks and devices for dissipating heat, and more particularly to a heatsink for dissipating head from an LED array light.

### BACKGROUND

LED light technology provides an efficient and long-lasting lighting alternative to halogen lighting. However, compared to conventional lighting technologies, LED lights generate a significant amount of heat. For example, the large amount of heat generated by LED arrays used as part of a parabolic aluminized reflector (PAR) light presents a particular heat dissipation problem.

Much thought has been given to solutions for efficiently dissipating heat from LED lights and light arrays. Some solutions, including specifically-designed heatsinks, may be effective at dissipating heat, but are not cost-effective because the associated manufacturing processes are not conducive to mass-production. For example, some known heatsinks for LED array lights are cast using common casting techniques. Unfortunately, common casting techniques do not lend well to efficient and cost-effective mass-production.

Other solutions are not adequately effective at dissipating heat. For example, some heatsinks use heat pipes to thermally couple different sections of the heatsink or to transfer heat from one heat dissipating element of the heatsink to another. Often the different sections or heat dissipating elements of such heatsinks are spaced-apart from each other such that the heat pipes provide the only means of heat transfer between the sections or elements. Although heat pipes provide a certain level of heat transferability, ultimately they lack the efficiency of other heat dissipating methods.

Additionally, certain known heatsinks include a plurality of sections each with protruding portions for dissipating heat. However, the protruding portions of each section protrude at different angles making each section different from one another. Because the plurality of sections are substantially non-identical, the manufacturing and assembly of such heatsinks can prove difficult, time-consuming, and expensive. Further, the protruding portions are not sized and/or shaped for efficient heat dissipation.

### SUMMARY

The subject matter of the present application has been developed in response to the present state of the art, and in particular, in response to the problems and needs in the art that have not yet been fully solved by currently available heatsinks for LED lights. Accordingly, the subject matter of the present application has been developed to provide various embodiments of a heat dissipating device and associated methods of manufacturing the device that overcome at least some of the above or other shortcomings of the prior art.

Generally, according to at least some embodiments, the subject matter of the present disclosure is directed to a heat dissipating device, or heatsink, for dissipating heat from an LED array light in an efficient and cost-effective manner. Instead of using casting techniques, the heat dissipating device of the present disclosure preferably is made using stamping or coining techniques. More specifically, in certain embodiments, the heat dissipating device is formed by stacking together a plurality of relatively thin, stamped, thermally conductive plates. Each stacked plate of the heat dissipating device is in direct contact with at least one adjacent plate to facilitate efficient heat transfer between the plates. Further, each stacked plate includes a plurality of spaced-apart and radially outwardly extending protrusions that increase the surface area of the plate and define heat collection zones, both of which act to increase heat losses from the plates and increase the heat dissipating efficiency of the device. Accordingly, the heat dissipating device of the present disclosure functions to efficiently dissipate heat from an LED array light in a manner that lowers the maximum operating temperature of the heat dissipating device below that of conventional heatsinks.

According to one embodiment, a heatsink that includes a plurality of thermally conductive plates coupled to each other in a stacked configuration. Each plate includes a core section and a plurality of protrusions extending radially outwardly from the core section in a direction substantially parallel to the core section. The core section of each plate is in direct contact with the core section of an adjacent plate.

In some implementations of the heatsink, each of the plurality of protrusions includes a base and a head coupled to the base. The base is positioned between the core section and the head. The head includes fractal geometric features. The fractal geometric features of the head can be a plurality of upright surfaces. The plurality of upright surfaces can be greater than three upright surfaces. In one implementation, the plurality of upright surfaces comprises at least twelve upright surfaces. In certain implementations, the fractal geometric features of the head include a plurality of upright edges where the plurality of upright edges includes greater than four upright edges. In one implementation, the plurality of upright edges includes at least eleven upright edges.

According to some implementations of the heatsink, each of the plurality of protrusions includes a base and a head coupled to the base where the base includes fractal geometric features. The fractal geometric features of the base can include a channel formed in an outer surface of the base. The channel can add at least one upright surface, at least one lateral surface, at least one upright edge, and at least one lateral edge to the base.

In certain implementations of the heatsink, each of the plurality of protrusions has a width and the plurality of protrusions of each plate are spaced a distance away from each other. The width of each protrusion can be less than the distance between each protrusion. The plurality of protrusions of each plate can be staggered relative to the plurality of protrusions of an adjacent plate such that the protrusions of each plate are aligned with spaces defined between the protrusions of an adjacent plate.

According to certain implementations of the heatsink, each protrusion has a width and the core section has an outer periphery from which the plurality of protrusions extend radially outwardly. The outer periphery can have a length and the width of each protrusion can be at most about 2% of the length of the outer periphery of the core section.

In some implementations, the plurality of thermally conductive plates of the heatsink are press-fit together. Each of the plurality of thermally conductive plates can include at least one aperture and at least one boss. The adjacent plates can be press-fit together via a press-fit engagement between the at least one boss of one of the adjacent plates and at least one aperture of the other of the adjacent plates.

According to some implementations, each of the plurality of protrusions has a substantially quadrangular-shaped cross-section along planes parallel to a width of the protrusions. In some implementations, each of the plurality of protrusions has a substantially circular-shaped or ovular-shaped cross-section along planes parallel to a width of the protrusions. In some implementations, each of the plurality of thermally conductive plates is made of a one-piece monolithic construction. In yet some implementations, heat transfer between the plurality of thermally conductive plates is facilitated substantially solely by conduction between the core sections of the plates.

In another embodiment, a thermally conductive plate includes a substantially disk-like core section defining a circular-shaped outer periphery, and a plurality of pin-like protrusions extending radially outwardly from the core section in a direction substantially parallel to the core section. Each of the plurality of protrusions has a width and the plurality of protrusions are spaced a distance away from each other such that the width of each protrusion is less than the distance between each protrusion.

According to one embodiment, a method of making a heatsink includes one of stamping and injection molding a plurality of thermally conductive plates. Each plate includes a core section, a plurality of protrusions extending radially outwardly from the core section in a direction substantially parallel to the core section, and first and second connection elements formed in the core section. The method includes stacking the plurality of thermally conductive plates together such that the core section of each plate is in flush-mounted contact with a core section of an adjacent plate. Further, the method includes engaging the first connection elements of each plate with the second connection elements of an adjacent plate to maintain the plurality of thermally conductive plates in a stacked configuration.

Reference throughout this specification to features, advantages, or similar language does not imply that all of the features and advantages that may be realized with the subject matter of the present disclosure should be or are in any single embodiment or implementation of the subject matter. Rather, language referring to the features and advantages is understood to mean that a specific feature, advantage, or characteristic described in connection with an embodiment is included in at least one embodiment of the subject matter of the present disclosure. Discussion of the features and advantages, and similar language, throughout this specification may, but do not necessarily, refer to the same embodiment or implementation.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a perspective view of a stackable plate of a heatsink according to one embodiment;

FIG. 2 is a top plan view of the stackable plate of FIG. 1;

FIG. 3 is a bottom plan view of the stackable plate of FIG. 1;

FIG. 4 is a detailed perspective view of a heat dissipating feature of the stackable plate of FIG. 1;

FIG. 5 is a detailed top plan view of a heat dissipating feature of the stackable plate of FIG. 1;

FIG. 6 is a perspective view of a heatsink including two stacked plates according to one embodiment;

FIG. 7 is a top plan view of the heatsink of FIG. 6;

FIG. 8 is a side view of the heatsink of FIG. 6;

FIG. 9 is a perspective view of a stackable plate of a heatsink according to another embodiment;

FIG. 10 is a perspective view of a heatsink including a plurality of stackable plates according to another embodiment; and

FIG. 11 is a perspective view of a stackable plate of a heatsink according to yet another embodiment.

### DETAILED DESCRIPTION

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the subject matter of the present disclosure, however, absent an express correlation to indicate otherwise, an implementation may be associated with one or more embodiments.

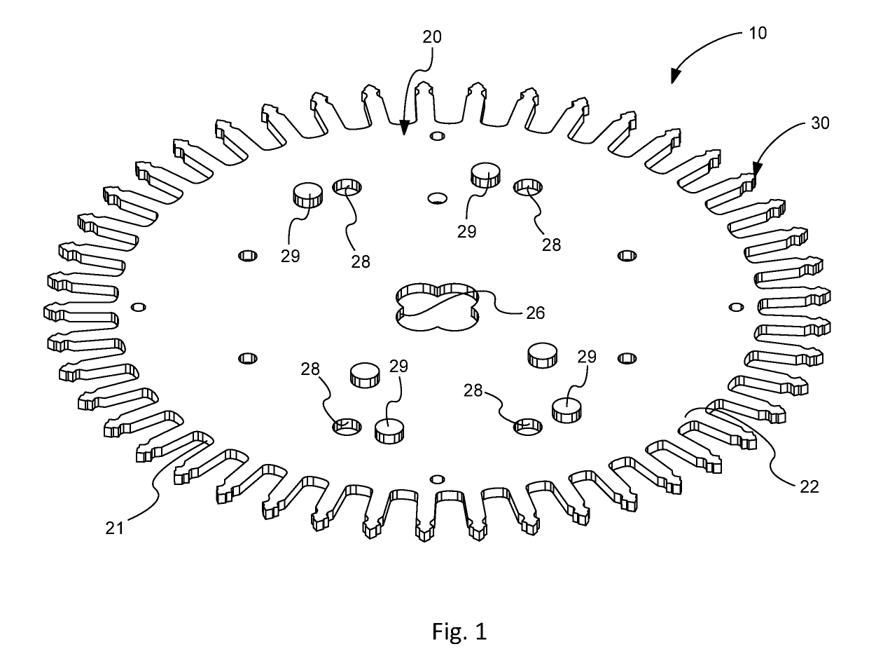

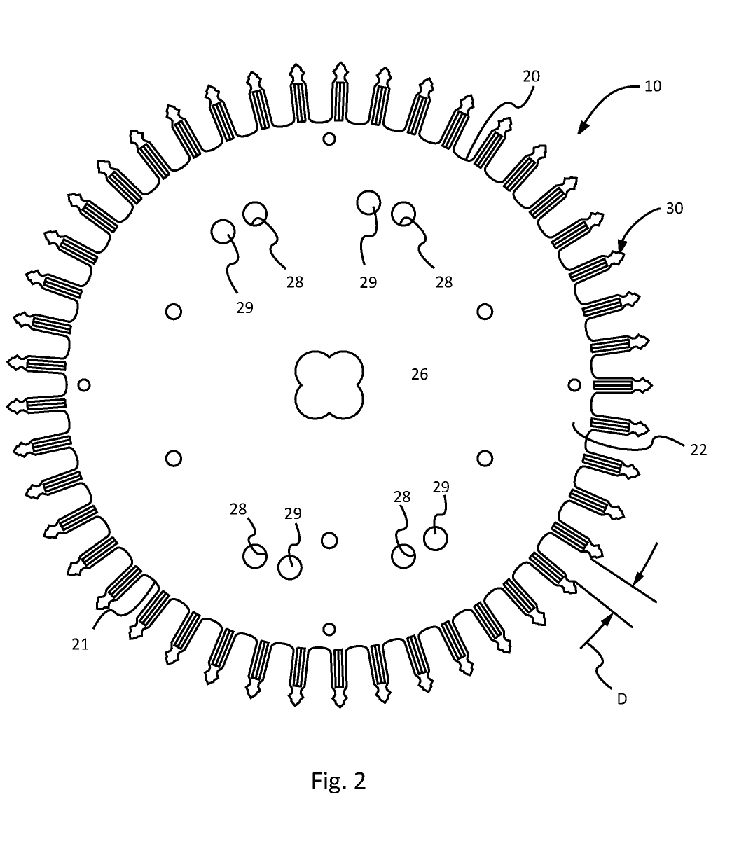

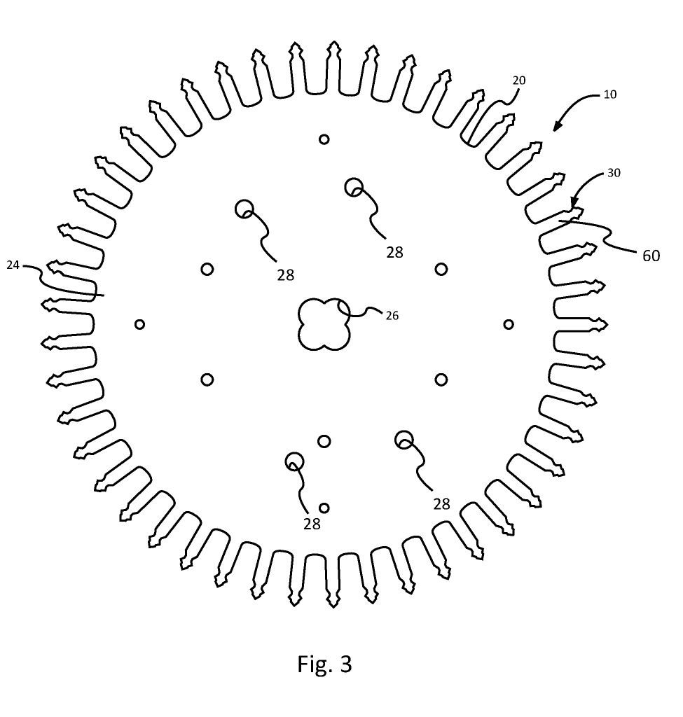

As discussed above, the heat dissipating device of the present disclosure includes a plurality of stackable plates in direct contact with each other. Referring to FIG. 1, each stackable plate 10 includes a core or core section 20 and a plurality of heat dissipating features 30 positioned about an outer periphery of the core. Generally, the core 20 is made of a flat, thin-walled plate having a first major surface 22 (e.g., an upper surface) (see FIG. 2) and a second major surface 24 (e.g., a lower surface) opposing the first major surface (see FIG. 3). The first and second major surfaces 22, 24 are spaced apart by a thickness of the plate and extend generally parallel to each other. Although not necessary, the core 20 has a generally disc-like shape with a circular outer periphery 21. In other implementations, the core 20 can have a thicker wall and/or have a generally non-circular outer periphery.

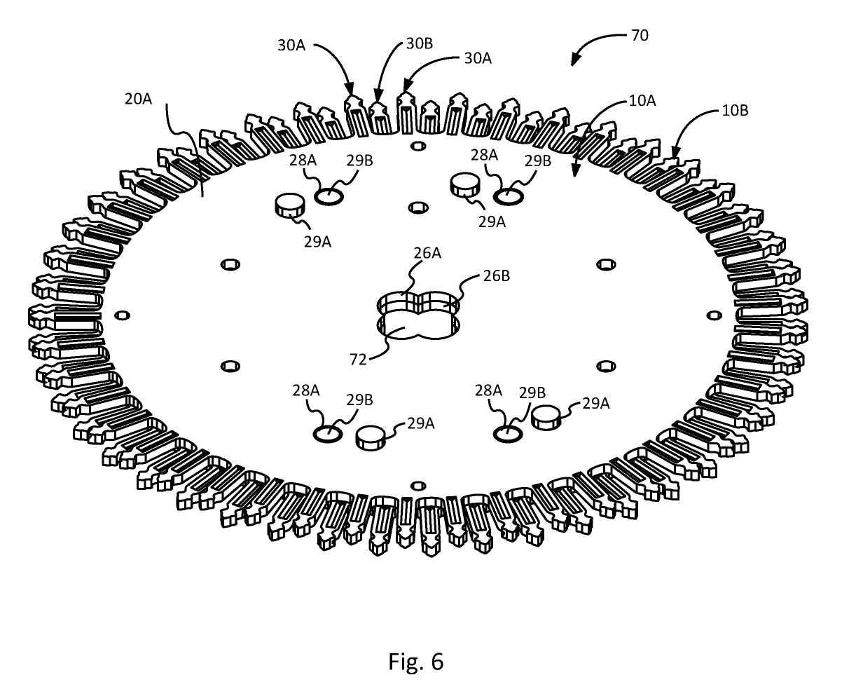

At a central location of the plate 10, the core 20 includes a central aperture 26. Further, positioned at predetermined locations on the first major surface 22 of the core 20 are a plurality of first connection elements (e.g., press-fit apertures 28) and a plurality of second connection elements (e.g., press-fit bosses 29). The locations of the plurality of press-fit apertures 28 are positioned on the first major surface 22 to correspond with a plurality of press-fit bosses 29 on an adjacent stackable plate. Similarly, the plurality of press-fit bosses 29 are positioned on the first major surface 22 to correspond with a plurality of press-fit apertures 28 on an adjacent stackable plate. Each of the press-fit apertures 28 is sized and shaped to press-fittingly receive a respective press-fit boss 29 of an adjacent plate (see, e.g., FIG. 6). Likewise, each of the press-fit bosses 29 is sized and shaped to be press-fittable within a respective press-fit boss 29 on an adjacent plate (see, e.g., FIG. 6). Although the illustrated press-fit apertures 28 and bosses 29 have a generally circular shaped cross-section, in other embodiments, the press-fit apertures and bosses can have cross-sectional shapes other than circular, such as triangular, rectangular, polygonal, ovular, and the like. In certain implementations, one or both of the apertures 28 and bosses 29 can have tapered sidewalls to facilitate a press-fit connection between apertures and bosses of adjacent plates. Although not shown, adjacent plates can be connected together using other techniques. For example, in one embodiment, one or more connecting elements can extend through respective alignable holes in each of the plates to align and connect the plates together in a stacked formation.

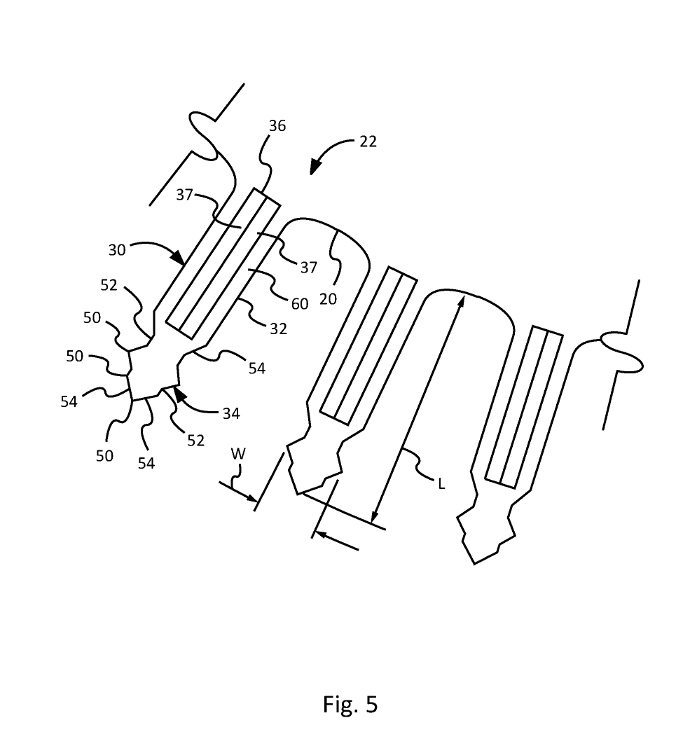

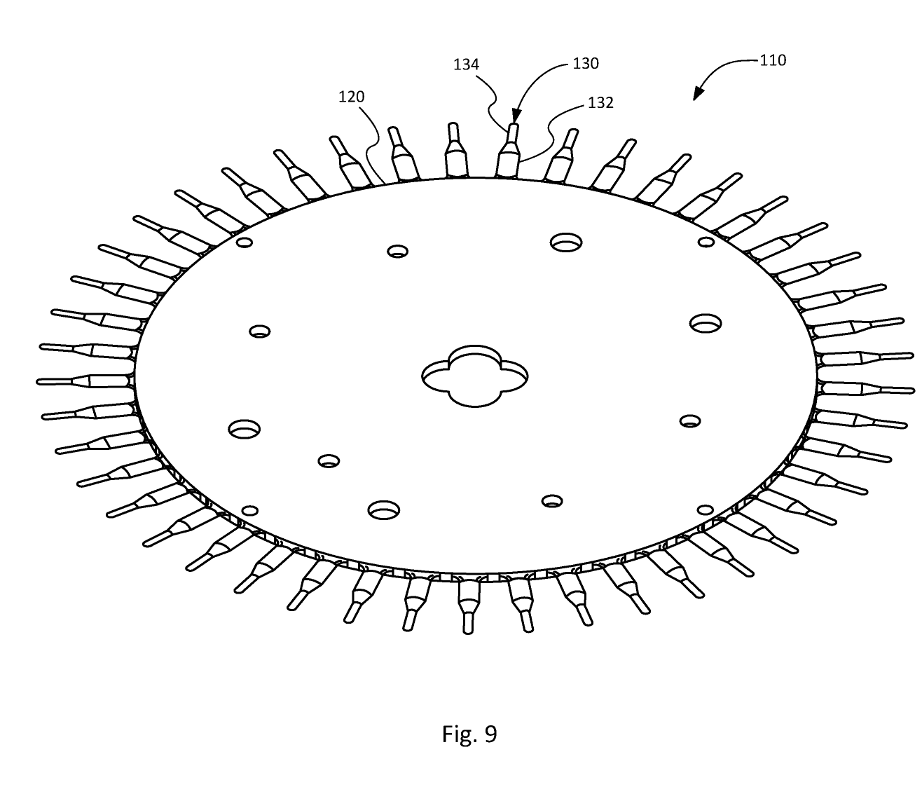

The heat dissipating features 30 are configured to increase (e.g., optimize) the surface area of the heat dissipation device and attract heat, which increases the heat loss from the heat dissipation device due to convection and increases the heat-dissipating efficiency of the device. As shown, the heat dissipating features 30 are pin-like elements that extend radially outward away from the outer periphery 21 of the core 20. The heat dissipating features 30 are spaced-apart about the outer periphery 21 of the core 20 by a distance D (see FIG. 2), which can be any of various distances as desired. In some implementations, the distance D between each feature 30 of the plate 10 is the same. In certain implementations, the distance D is dependent upon the width W of the heat dissipating features 30 (see FIG. 5). In one implementation, the distance D is greater than the width W (i.e., the width W is less than the distance D) to facilitate non-overlapping staggering of the heat dissipating features of adjacent plates when the plates are stacked together. Additionally, because the heat dissipating features 30 are pin-like (as opposed to fin-like) in certain embodiments, the width W of each heat dissipating feature is less than about 2% of the circumference or length of the outer periphery 21 of the core 20. Because the width W of each heat dissipating feature is substantially small compared to the circumference of the core, each plate 10 includes a significantly higher number of heat dissipating elements (and consequently more heat-attracting edges and heat-dissipating surfaces) than conventional heatsink sections. The heat dissipating features 30 can have the same thickness as the core 20 or a different thickness than the core (see, e.g., the heat dissipating features 130 of FIG. 9 have a thickness that is less than the core). In the illustrated embodiments, the thickness of the heat dissipating features 30 is the same or less than the thickness of the core 20.

Moreover, in the illustrated embodiments, the heat dissipating features 30 extend outwardly from the outer periphery 21 in a direction that is parallel (e.g., non-angled) with the core 20. According to one embodiment, the heat dissipating features 30 are parallel the core when the heat dissipating features are parallel with respect to the first and second major surfaces 22, 24 of the core 20, or alternatively, parallel to a length or width of the core 20, where the length or width is substantially greater than a thickness of the core. Accordingly, the heat dissipating features 30 can be co-planer with (or positioned within the confines of) the planes defined by the first and second major surfaces 22, 24.

In certain embodiments, the thickness of the heat dissipating features 30 being the same or less than the thickness of the core 20, and the heat dissipating features being parallel or co-planer with the core 20, allow any number of plates 10 to be stacked together to form a heatsink having any of various sizes. This is because the heat dissipating features of adjacent plates do not interfere with each other so as to limit the number of sections forming the heatsink as with some prior art devices. Alternatively, as will be described in more detail below, in some embodiments where the plates are staggered, the thickness of the heat dissipating features 30 can be greater than the thickness of the core without interfering with the heat dissipating features of adjacent plates.

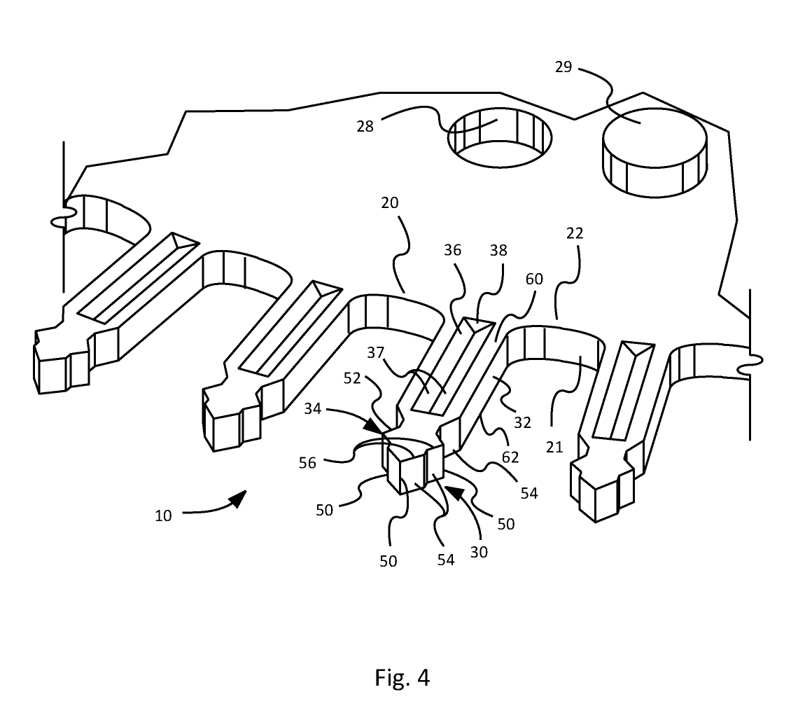

Referring to FIGS. 4 and 5, each heat dissipating feature 30 includes an elongate base 32 and a head 34. The base 32 is coupled to the periphery 21 of the core 20 at a first end and the head 34 at a second end opposite the first end. In certain embodiments, one or both of the base 32 and head 34 employ fractal geometry to increase the overall surface area of each heat dissipating feature 30, as well as to draw heat from the core 20 into each heat dissipating feature 30. As defined herein, in one embodiment, fractal geometry can be defined as a rough or fragmented geometric shape that can be split into parts, each of which is at least approximately a reduced-sized copy of the whole.

For example, according to the illustrated embodiment, the base 32 includes fractal geometric features, i.e., channel 36, to increase the surface area of the base and attract heat. Generally, in certain embodiments, incorporating fractal geometric features into a base with a substantially uniform cross-sectional area (e.g., with a common shape) along its length includes adding one or more surfaces and/or edges to the base above the number of surfaces and edges associated with a base with a substantially uniform cross-sectional area or common shape. For example, a rectangular-shaped or box-shaped base, such as base 32, includes at most two upright surfaces, two lateral surfaces, four upright edges, and four lateral edges. Accordingly, the fractal geometric features of the base would add at least one of one or more upright or angled surfaces, one or more lateral surfaces, one or more upright or angled edges, and one or more lateral edges. As shown, the channel 36 is formed in a single surface of the base 32 and extends lengthwise along the base. The channel 36 is defined by two elongate angled surfaces 37 converging to a point, and two opposing end surfaces 38 at respective opposing ends of the channel 36. Because the channel 36 adds multiple edges (e.g., five lateral edges, four upright or angled edges) to the elongate base 32 to attract heat and multiple surfaces (e.g., four upright or angled surfaces) to an original single surface of the commonly-shaped base, the number of edges and surfaces (e.g., the surface area of the elongate base 32) with the channel 36 is greater than the surface area of the elongate base without the channel. Accordingly, the capacity of the elongate base 32 to dissipate heat via convection is greater with the fractal geometric feature (e.g., channel 36) than without the feature. Although the channel 36 includes four surfaces, in other embodiments, the base 32 can include different surface area promoting features with fewer or more than four surfaces. Additionally, although the channel 36 has a substantially triangular cross-sectional shape, in other embodiments, the channel 36 can have cross-sectional shapes other than triangular, such as rectangular, circular, ovular, and the like.

The head 34 illustrated in FIGS. 4 and 5 also includes fractal geometry in the form of multiple surfaces and edges therebetween, or, as defined in some embodiments, more edges and surfaces than the base to which the head is coupled. For example, a rectangular base coupling a head to the core includes at most two upright surfaces, two lateral surfaces, four upright edges, and four lateral edges. Accordingly, the fractal geometric features of the head would include at least one of more than two (or three) upright surfaces, more than two lateral surfaces, more than four upright edges, and more than four lateral edges. Incorporating fractal geometry in the head 34 acts to restrict or resist thermal energy flow within the head, such that heat accumulates or gravitates to the fractals of the head, where the heat is dissipated to the environment via convection. Generally, the head 34 is a feature at a radially outward extent of each heat dissipating feature 30 that includes a plurality of surfaces and edges (i.e., more surfaces and edges than the base). For example, the base may include only two upright surfaces, four upright edges, and four lateral edges, while the head 34 includes twelve upright surfaces 54, eleven upright edges 50, 52 each forming the junction of a respective two of the surfaces 54, and twenty-four lateral edges 56. The upright edges are made up of outward edges 50 and inward edges 52. The twenty-four lateral edges 56 include twelve pair of lateral edges where each pair is associated with a respective surface 54. Each of the edges 50, 52, 56 facilitates the migration of at least some heat energy about the edges. From the edges 50, 52, 56, the heat is transferred to the upright surfaces 54, or upper or lower surfaces of the head 30, from which the heat is dissipated via convection.

As defined herein, a surface of a fractal geometric feature is a single, substantially smooth surface uninterrupted by significant non-smooth features, such as points or edges. Defined another way, a surface can be any surface defined between edges. An edge, as defined herein, includes a sharp line, angle, or corner between at least two adjacent surfaces. Sharp can mean precise, distinct, acute, substantially pointed, substantially non-rounded, and/or substantially non-blunt, but does not connote the ability to cut or pierce something. Generally, in certain embodiments, an edge as defined herein is sufficiently sharp so as to effectively attract heat.

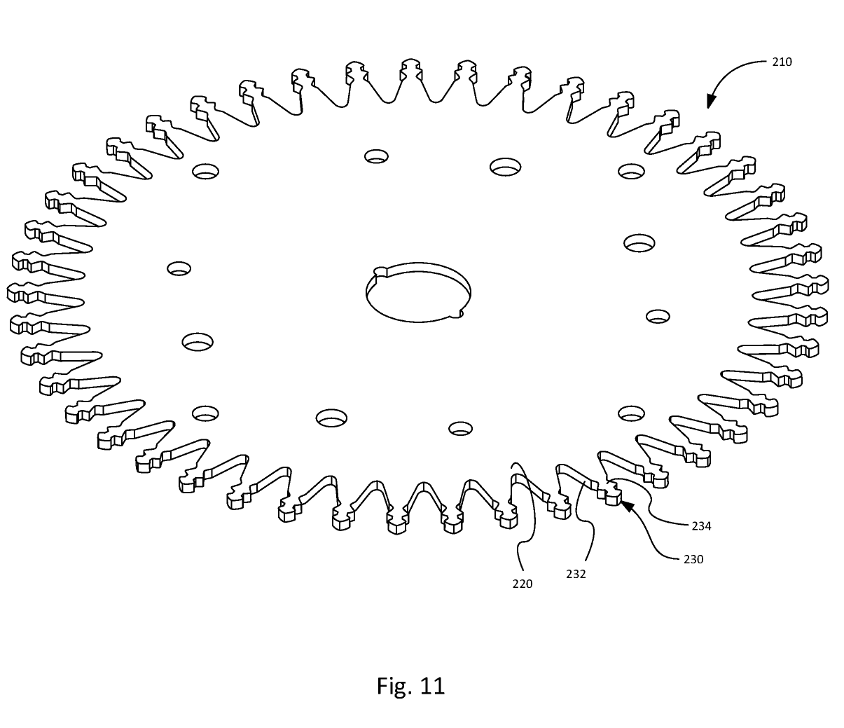

The head 34 includes a specific configuration of multiple surfaces and edges that define a somewhat irregular shape. In other implementations, the head 34 includes a plurality of surfaces and edges configured in a different configuration and shape than that shown in FIGS. 4 and 5. For example, as shown in FIG. 9, the head 134 is substantially cylindrical. As another example, FIG. 11 shows one embodiment of a head 234 that effectively includes two somewhat diamond-shaped heads coupled to each other. The additional fractals of the head 234 improve the effectiveness of attracting heat to the fractals and dissipating heat from the plate 210. The heat dissipating feature 230 can be thought of as replacing a portion of the base 232 with additional fractal geometry in the form of a second head 234 such that the length of the head portion increases while the length of the base decreases. Accordingly, if desired, fractal geometry can extend along the sides of the base to effectively replace the base with an elongated head portion.

Although the heat dissipating features 30 can have any of various thicknesses relative to the thickness of the core 20, in the illustrated embodiment, the thickness T of the heat dissipating features is approximately the same as the thickness of the core (see FIG. 4). Each heat dissipating feature 30 is further dimensioned by a length L and width W. The length L plus a radius of the core 20 defines an overall radius of the plate 10. The width W can be any of various widths. However, in preferred embodiments, the width W is less than the distance D between adjacent heat dissipating features 30 and less than the length L. The width W of each base can be constant along a length of the base, such as, for example, the base 32 of protrusion 30. Alternatively, the width W of each base can change in a radial direction away from a core of the plate. For example, referring to FIG. 11, the width W of the base 232 of the heat dissipating feature 230 decreases in a radial direction away from the core 220 of the plate 210 such that the base 232 is substantially triangularly-shaped when viewed from above. The width W of the heat dissipating feature 30 refers generally to the overall width or maximum width of the feature. Accordingly, the base can have a first width and the head can have a second width different (e.g., larger or shorter) than the width of the base. The overall width W of the heat dissipating Additionally, the thickness T of the heat dissipating features is less than the length L of the features in preferred embodiments. In some implementations, the length L of each feature 30 is significantly greater than the width W of the feature. In one implementation, the length L is at least 2 times the width W, and in some implementations, the length L is at least 4 times the width W.

The heat dissipating features or protrusions 30 of the plate 10 have a generally quadrangular-shaped (e.g., rectangular-shaped or square-shaped) cross-section along planes parallel to the width W of the heat dissipating features. However, in other embodiments, the cross-sectional shape of the features 30 can be shapes other than quadrangular, such as triangular, polygonal, elliptical, circular, and the like. For example, as shown in FIG. 9, the stackable plate 110 includes heat dissipating protrusions or pins 130 that have a generally circular-shaped or ovular-shaped cross-section along planes parallel to a width of the protrusions. Similar to the protrusions 30 of the plate 10, the protrusions 130 of the plate 110 include a base 132 and head 134 coupled to the base. The base 132 is wider than the head 134 and has an ovular-shaped cross-section. The head 134 is substantially pin-like with a circular cross-section. Like the plate 10, the protrusions 130 of the plate 110 are spaced apart about a periphery of a core 120 of the plate. However, the protrusions 130 have a minimum thickness that is less than the thickness of the core of the plate 110.

In yet other embodiments having full or 3-dimensional heat dissipating features, the cross-sectional shape can be any of various irregular shapes based on the full dimensional shape of the heat dissipating feature. In the illustrated embodiment of the plate 10, the heat dissipating features 30 have relatively flat or planar first (e.g., upper) and second (e.g., lower) surfaces 60, 62 (e.g., lateral surfaces) (see FIG. 4) that are coplanar with the first and second major surfaces 22, 24, respectively, of the core 20. Heat dissipating features having such flat or planar first and second surfaces 60, 62 are defined herein as being 2-dimensional despite the head being 3-dimensional according to the traditional definition. However, with advanced manufacturing techniques, as will be discussed in more detail below, the planarity of the first and second surfaces 60, 62 can be eliminated such that the fractal geometries (e.g., edges and surfaces) can be added to the top and bottom of the heads 30, in addition to the sides as shown in the illustrated embodiments. Because these latter heads have fractal geometries formed in the top, bottom, and side surfaces of the heads, such heads can be defined herein as full or 3-dimensional heat dissipating features.

Although the heat dissipating features 30, 130 shown in the illustrated embodiments are generally pin-line elements, in other embodiments, the heat dissipating features can be fins, tabs, or other types of projections.

Each stackable plate 10, 110 is stamped using common stamping techniques. Accordingly, each stackable plate 10, 110 is formed from the same billet of material such that each stackable plate is formed of a one-piece monolithic construction, including the plurality of heat dissipating features 30, 130. Generally, the stamping or coining process involves positioning a billet of material over or within a die and applying a pressure to the billet to plastically deform the billet to conform to the shape of the die. The stackable plates 10 can be made from aluminum, copper, or other materials with a high thermal conductivity. Because stamping techniques are more conducive to mass-production than casting techniques, the stackable plates 10, 110 can be mass-produced at a very high rate compared to cast components. Notwithstanding the above, each plate 10, 110 can be formed using other techniques, such as casting, extruding, injection molding, and machining. For example, in some embodiments, particularly when copper or aluminum is used as the forming material, each stackable plate can be formed using a metal injection molding technique. The use of injection molding techniques are particularly conducive to forming 3-dimensional heat dissipating heads as discussed above.

Referring to FIG. 6, a heatsink 70 is formed by stacking a plurality of stackable plates on top of each other. For convenience, the heatsink 70 is shown with just two stackable plates 10A, 10B with plate 10A being stacked on plate 10B. Plates 10A, 10B are nearly identical to plate 10 as described above. In other words, both plates 10A, 10B include a core and heat dissipating features 30A, 30B, respectively. However, the positioning of the press-fit apertures 28A, 28B and press-fit bosses 29A, 29B relative to the central apertures 26A, 26B, respectively, are different on the plates 10A, 10B. Generally, the positioning of the press-fit apertures 28A and bosses 29A relative to the central aperture 26A is circumferentially offset from the positioning of the press-fit apertures 28B and bosses 29B relative to the central aperture 26B. In this manner, the central apertures 26A, 26B of the plates 10A, 10B are aligned to form a central channel 72 when the bosses 29B of the bottom plate 10B are press-fit within respective apertures 28A of the top plate 10A as shown in FIG. 6.

Although the stackable plates 10A, 10B are secured to each other using press-fitting techniques, in other embodiments, other coupling techniques can be used. For example, in some embodiments, the stackable plates of a heatsink (e.g., the stackable plates 10A, 10B of the heatsink 70) can be secured to each other using fastening, riveting, pinning, adhering (e.g., gluing), welding, and/or other similar techniques.

When stacked together, the cores 20A, 20B of the plates 10A, 10B sit flush against each other (i.e., are flush mounted) such that the cores are directly in contact with each other (see FIG. 8). In other words, the lower major surface 24A of the core 20A is in flush-mounted contact with the upper major surface 24B of the core 20B. Because the cores of adjacent stacked plates are in direct contact with each other, heat transfer between the plates is performed nearly solely by conduction between the cores without the need for heat pipes or other heat transfer facilitating elements. Moreover, because heat pipes and other heat transfer facilitating elements are not necessary, the construction of the heatsink 70 is not only simple and clean, but cost-effective.

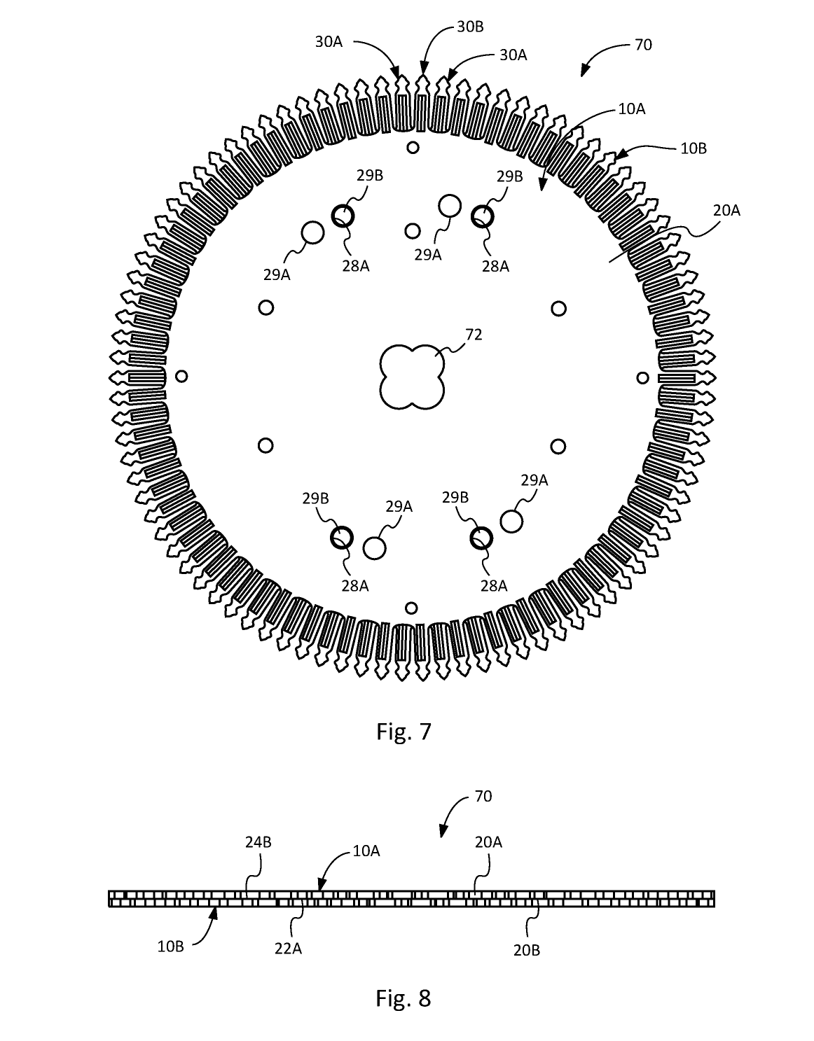

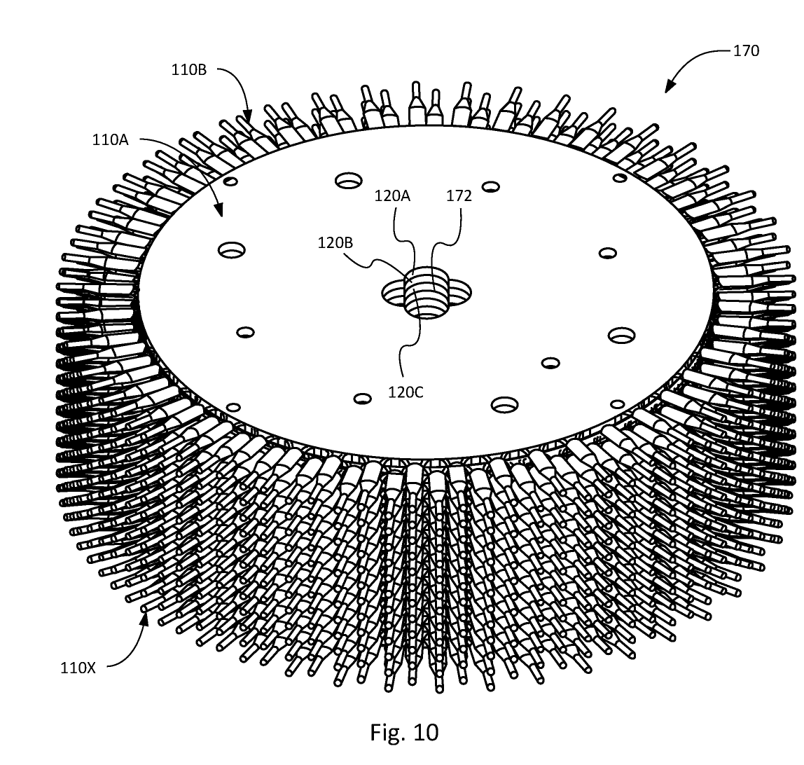

As shown in FIG. 7, when stacked together, the heat dissipating elements 30A, 30B of the plates 10A, 10BA, respectively, are not in contact with each other (e.g., are spaced apart) such that the entire surface of each heat dissipating feature is available for heat convection. Like the apertures and bosses of the plates, the positioning of the plurality of the elements 30A relative to the central aperture 26A is circumferentially offset from the positioning of the plurality of the elements 30B relative to the central aperture 26A. Accordingly, when the plates 10A, 10B are stacked together, the heat dissipating features 30A are staggered relative to the heat dissipating features 30B. When staggered, the plurality of protrusions each plate are aligned with the spaces defined between the protrusions of an adjacent plate. In some implementations, when viewed from above, the protrusions of one plate are positioned entirely between the protrusions of an adjacent plate. According to such implementations, due to the staggered nature of the heat dissipating features 30A, 30B, the spaces between the heat dissipating features 30A appear to be occupied by the heat dissipating features 30B of the adjacent plate 10B when viewed from above the heatsink 70 as shown in FIG. 7. This staggered formation is maintained from plate to plate throughout the heatsink regardless of the number of plates forming the heatsink (see, e.g., heatsink 170 of FIG. 10). Although the heat dissipating features in the illustrated embodiments are oriented in a staggered formation, in other embodiments, the heat dissipating features of adjacent plates of a heatsink need not be in a staggered formation, but could be vertically aligned or at least partially vertically aligned.

The heatsink made from stackable plates as defined herein can include any number of plates. The heatsink 70 is shown with only two stackable plates 10A, 10B for the sake of simplicity only. In other words, the heatsink 70 could include many more than two stackable plates arranged in a manner as described above. For example, FIG. 10 shows a heatsink 170 with twenty-four stacked plates 110A-110X. FIG. 10 also illustrates the formation of a central channel 172 formed by the aligned central apertures 120A-120X of the plates. The central channel 172, as well as central channel 72, is usable as a conduit to house wires and other components necessary for providing power and control to an LED array light attached to the associated heatsink.

The subject matter of the present disclosure may be embodied in other specific forms without departing from its spirit or essential characteristics. The described embodiments are to be considered in all respects only as illustrative and not restrictive. The scope of the subject matter of the present disclosure is, therefore, indicated by the appended claims rather than by the foregoing description. All changes which come within the meaning and range of equivalency of the claims are to be embraced within their scope.

What is claimed is:

1. A heatsink, comprising:
a plurality of thermally conductive plates coupled to each other in a stacked configuration;
wherein each plate comprises a core section and a plurality of protrusions extending radially outwardly from the core section in a direction substantially parallel to the core section, the core section of each plate being in direct contact with the core section of an adjacent plate.

2. The heatsink of claim 1, wherein each of the plurality of protrusions comprises a base and a head coupled to the base, the base being positioned between the core section and the head, and wherein the head comprises fractal geometric features.

3. The heatsink of claim 2, wherein the fractal geometric features comprise a plurality of upright surfaces, wherein the plurality of upright surfaces comprises greater than three upright surfaces.

4. The heatsink of claim 3, wherein the plurality of upright surfaces comprises at least twelve upright surfaces.

5. The heatsink of claim 2, wherein the fractal geometric features comprise a plurality of upright edges, wherein the plurality of upright edges comprises greater than four upright edges.

6. The heatsink of claim 5, wherein the plurality of upright edges comprises at least eleven upright edges.

7. The heatsink of claim 1, wherein each of the plurality of protrusions comprises a base and a head coupled to the base, the base being positioned between the core section and the head, and wherein the base comprises fractal geometric features.

8. The heatsink of claim 2, wherein the fractal geometric features comprise a channel formed in an outer surface of the base.

9. The heat sink of claim 8, wherein the channel adds at least one upright surface, at least one lateral surface, at least one upright edge, and at least one lateral edge to the base.

10. The heatsink of claim 1, wherein each of the plurality of protrusions has a width, and wherein the plurality of protrusions of each plate are spaced a distance away from each other, and wherein the width of each protrusion is less than the distance between each protrusion.

11. The heatsink of claim 10, wherein the plurality of protrusions of each plate are staggered relative to the plurality of protrusions of an adjacent plate such that the protrusions of each plate are aligned with spaces defined between the protrusions of an adjacent plate.

12. The heatsink of claim 1, wherein each protrusion has a width and the core section has an outer periphery from which the plurality of protrusions extend radially outwardly, the outer periphery having a length, and wherein the width of each protrusion is at most about 2% of the length of the outer periphery of the core section.

13. The heatsink of claim 1, wherein the plurality of thermally conductive plates are press-fit together.

14. The heatsink of claim 11, wherein each of the plurality of thermally conductive plates comprises at least one aperture and at least one boss, and wherein adjacent plates are press-fit together via a press-fit engagement between the at least one boss of one of the adjacent plates and at least one aperture of the other of the adjacent plates.

15. The heatsink of claim 1, wherein each of the plurality of protrusions has a substantially quadrangular-shaped cross-section along planes parallel to a width of the protrusions.

16. The heatsink of claim 1, wherein each of the plurality of protrusions has a substantially circular-shaped or ovular-shaped cross-section along planes parallel to a width of the protrusions.

17. The heatsink of claim 1, wherein each of the plurality of thermally conductive plates is made of a one-piece monolithic construction.

18. The heatsink of claim 1, wherein heat transfer between the plurality of thermally conductive plates is facilitated substantially solely by conduction between the core sections of the plates.

19. A thermally conductive plate, comprising:
a substantially disk-like core section defining a circular-shaped outer periphery;
a plurality of pin-like protrusions extending radially outwardly from the core section in a direction substantially parallel to the core section, each of the plurality of protrusions having a width, the plurality of protrusions being spaced a distance away from each other, wherein the width of each protrusion is less than the distance between each protrusion.

20. A method of making a heatsink, comprising:
one of stamping and injection molding a plurality of thermally conductive plates, each plate comprising a core section, a plurality of protrusions extending radially outwardly from the core section in a direction substantially parallel to the core section, and first and second connection elements formed in the core section;
stacking the plurality of thermally conductive plates together such that the core section of each plate is in flush-mounted contact with a core section of an adjacent plate; and
engaging the first connection elements of each plate with the second connection elements of an adjacent plate to maintain the plurality of thermally conductive plates in a stacked configuration.
